(19) United States
(12) Patent Application Publication
(10) Pub. No.: US 2014/0229752 A1
(43) Pub. Date: Aug. 14, 2014

(54) USER DEVICE AND OPERATION METHOD THEREOF

(71) Applicant: Samsung Electronics Co., Ltd., Gyeonggi-do (KR)

(72) Inventor: Jung-Hyun LEE, Seoul (KR)

(73) Assignee: Samsung Electronics Co., Ltd., Gyeonggi-do (KR)

(21) Appl. No.: 14/073,193

(22) Filed: Nov. 6, 2013

(30) Foreign Application Priority Data
Feb. 8, 2013 (KR) 10-2013-0014677

(51) Int. Cl. G06F 1/32

(52) U.S. Cl. CPC G06F 1/3234
USPC 713/323

(57) ABSTRACT

An operation method of an electronic device includes performing a sleep mode and at least one function that is allowed during the sleep mode, if at least one preset condition is satisfied.

### PRIORITY

This application claims priority under 35 U.S.C. §119 to an application filed in the Korean Intellectual Property Office on Feb. 8, 2013 and assigned Serial No. 10-2013-0014677, the contents of which are incorporated herein by reference.

### BACKGROUND OF THE INVENTION

1. Field of the Invention

The present invention generally relates to a user device and an operation method thereof and more particularly, to a user device and an operation method that improves a user device usability during a time period when the user device is not being used.

2. Description of the Related Art

As electronic communication systems develop, user devices such as mobile communication terminals (cellular phones), electronic notebooks, and personal multi function peripheral devices are becoming necessities in modern society and are thus becoming an important means for delivering information. Moreover, since the user devices may also provide various data transmission services and various additional services in addition to a voice call service, the devices have changed to multimedia communication devices in function. Moreover, user devices that employ touch screens are being commercialized, and the number of services that may be provided through the user devices increases. In addition, a user interface (UI) technology that controls the user devices is also being developed.

Such a user device provides user customized information according to user preferences and the surrounding environment. However, when the user device is not used, such as when the user device is being charged through a charger or a user is sleeping, there is a drawback in that user device's usability decreases.

### SUMMARY OF THE INVENTION

The present invention has been made to substantially solve at least the above problems and/or disadvantages and to provide at least the advantages below. Accordingly, an aspect of the present invention provides a user device and an operation method thereof that improves the user device's usability during a time period when the user device is not being used.

Another aspect of the present invention provides a user device and an operation method thereof that increases the user device's usability by providing user customized information throughout the user's life, in particular even in a situation where the user device is not being used during sleep.

Another aspect of the present invention provides a user device and an operation method thereof that additionally provides customized information related to a schedule.

Another aspect of the present invention provides a user device and an operation method thereof that determines the suitability of a schedule from customized information related to a schedule and induces a user to rearrange the schedule if the schedule is unsuitable.

Another aspect of the present invention provides a user device and an operation method thereof that determines situations where a user device is not being used and provides a user customized function during these situations.

According to an aspect of the present invention, an operation method of a user device includes performing a sleep mode if at least one condition that is preset is satisfied; and performing at least one function that is allowed in the sleep mode.

According to another aspect of the present invention, a user device includes at least one processor; a memory; and at least one program stored in the memory, wherein the at least one program is executable by the at least one processor, performs a sleep mode if at least one condition that is preset is satisfied, and performs at least one function that is allowed in the sleep mode.

### BRIEF DESCRIPTION OF THE DRAWINGS

The above and other aspects, features and advantages of the present invention will become more apparent from the following detailed description, taken in conjunction with the accompanying drawings, in which:

FIG. 1 is a block diagram of a user device to which the present invention may be applied;

FIG. 2 is a flowchart of a procedure of performing a sleep mode according to an embodiment of the present invention;

FIGS. 3 to 6 are flowcharts related to step 201 of FIG. 2;

FIG. 7 is a flowchart of a procedure of performing a sleep mode according to an embodiment of the present invention;

FIGS. 8 and 9 are flowcharts related to step 209 of FIG. 2 and step 707 of FIG. 7; FIG. 10 is a flowchart related to step 911 of FIG. 9;

FIG. 11 is a flowchart related to step 801 of FIG. 8 and step 901 of FIG. 9;

FIG. 12 is a screen of a user device according to an embodiment of the present invention; and

FIGS. 13 to 20B are screens of a user device regarding a sleep mode according to an embodiment of the present invention.

### DETAILED DESCRIPTION OF EMBODIMENTS OF THE PRESENT INVENTION

Embodiments of the present invention will be described below in more detail with reference to the accompanying drawings. Moreover, detailed descriptions related to well-known functions or configurations will be omitted herein in order to avoid obscuring the subject matter of the present invention. The terms described below are those defined by considering the functions in embodiments of the present invention and may vary depending on the intention of a user or an operator or in practice. Therefore, the definitions will be made on the basis of the content throughout the description herein.

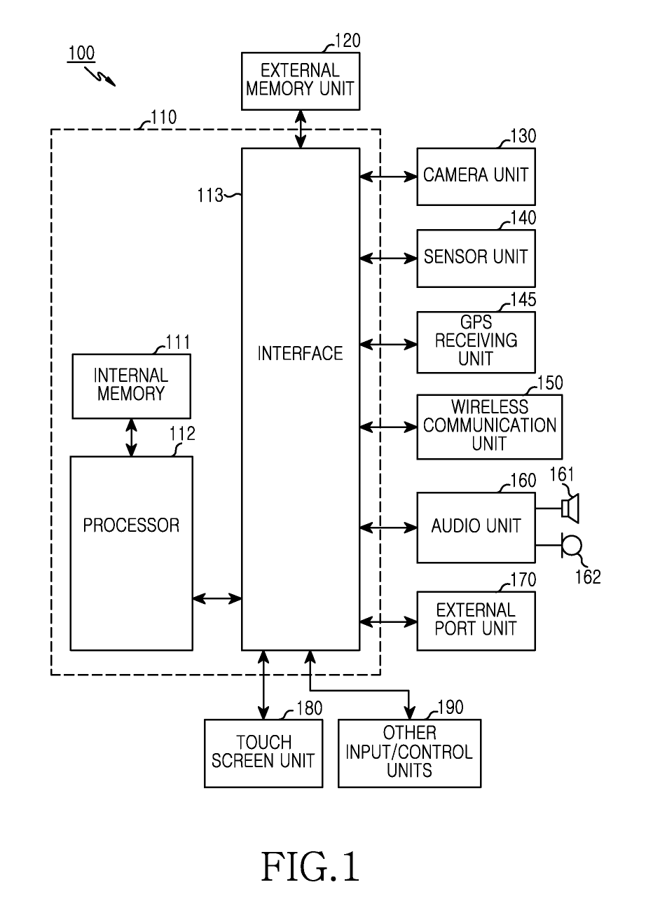

FIG. 1 is a block diagram of a user device to which the present invention may be applied.

A user device 100 may be a device such as a mobile phone or pad, a media player, a tablet computer, a handheld computer or a Personal Digital Assistant (PDA). Moreover, it may also be any user device that includes a device having the functions of two or more of these devices.

The user device 100 includes a host unit 110, an external memory unit 120, a camera unit 130, a sensor unit 140, a global positioning system (GPS) receiving unit 145, a wireless communication unit 150, an audio unit 160, an external port unit 170, a touch screen unit 190, and other input/control units 180. Each of the external memory unit 120 and the external port unit 170 may be in plural.

The host unit 110 includes an internal memory 111, one or more processors 112 and an interface 113. The internal memory 111, the one or more processors 112 and the interface 113 may be separate components or configured in one or more integrated circuit elements.

The processor 112 executes several software programs, performs several functions for the user device 100, and performs processing and control for voice, image, and data communication. Moreover, in addition to these typical functions, the processor 112 executes a software program (a set of instructions) that is stored in the internal memory 111 and/or the external memory unit 120, and performs several functions corresponding to the program. Moreover, in addition to these typical functions, the processors 112 executes a specific software program that is stored in the internal memory 111 and/or the external memory unit 120, and also plays a role in performing several specific functions corresponding to the program. That is, the processor 112 is linked to software programs stored in the internal memory 111 and/or the external memory unit 120 and performs a method according to an embodiment of the present invention. Moreover, the processor 112 may include one or more data processors, an image processor, or a codec. Furthermore, the user device 100 may also configure the data processors, the image processor or the codec separately.

The interface 113 connects the several units of the user device 100 to the host unit 110. The camera unit 130 may perform camera functions such as recording pictures and video clips. The camera unit 130 may include a charged coupled device (CCD) or a complementary metal-oxide semiconductor (CMOS). Moreover, the camera unit 130 may change hardware aspects according to a camera program which the processor 112 executes. For example, according to the camera program, the camera unit 130 may move lens or adjusts the f-Number of the iris.

The various components of the user device 100 may be connected through one or more communication buses (without reference numeral) or a stream line (without reference numeral).

The sensor unit 140 includes a motion sensor, a photo sensor, a temperature sensor, etc. and enables several functions. For example, the motion sensor may sense the motion of the user device 100 and the photo sensor may sense ambient light. The GPS receiving unit 145 receives a signal sent from a GSP satellite and calculates the current location. The wireless communication unit 150 enables wireless communication. The wireless communication unit 150 may include wireless frequency transceiver and an optical (e.g., infrared) transceiver. The wireless communication unit 150 may be designed to operate according to a communication network such as one of Global System for Mobile Communication (GSM), Enhanced Data GSM Environment (EDGE), Code Division Multiple Access (CDMA), W-Code Division Multiple Access (W-CDMA), Long Term Evolution (LTE), Orthogonal Frequency Division Multiple Access (OFDMA), Wireless Fidelity (Wi-Fi), WiMax and/or Bluetooth networks.

The audio unit 160 is connected to the speaker 161 and the microphone 162 and is responsible for the input and output of audio such as voice recognition, voice copy, digital recording and call functions. That is, the audio unit 160 communicates with a user through the speaker 161 and the microphone 162. Moreover, the audio unit 160 may receive a data signal from the host unit 110, convert the received data signal into an electrical signal, and output the electrical signal through the speaker 161. The speaker 161 may convert and output the electrical signal into an audible frequency band, and the microphone 162 may convert a sound wave delivered from a human being or other sound sources into an electrical signal. Moreover, the audio unit 160 may receive the electrical signal from the microphone 162, convert the received electrical signal into an audio data signal, and transmit the audio data signal to the host unit 110. The audio unit 160 may include a detachable earphone, a head phone or a head set that may be connected and disconnected to and from the user device 100.

The external port unit 170 connects the user device 100 to another user device directly or indirectly through a network (e.g., internet, intranet, wireless LAN, etc.). The external port unit 170 may include a socket that is arranged on the back of the user device 100.

The touch screen unit 190 provides input and output interface between the user device 100 and a user. The touch screen device 190 employs a touch sensing technology, delivers a user touch input to the host unit 110 and shows visual information provided from the host unit 110, such as a text, a graphic, a video, etc. to the user. The touch screen unit 190 includes a display on which an image is displayed, and such a display may be one of an Electro Wetting Display (EWD), E-Paper, a Plasma Display Panel (PDP), a Liquid Crystal Display (LCD), an Organic Light Emitting Diode (OLED), and an Active Matrix Organic Light Emitting Diodes (AMOLED). Moreover, the touch screen unit may include a device that receives a touch, and such a device may be one of a digitizer for a stylus pen, a capacitive overlay touch panel, a resistive overlay touch panel, a surface acoustic wave touch panel, and an infrared beam touch panel.

The other input/control units 190 may include up/down buttons for controlling volume. In addition, the other input/control units 190 may include at least one of pointer units that include a push button having a corresponding function, a locker button, a locker switch, a thumb-wheel, a dial, a stick, and a stylus.

The external memory unit 120 includes one or more high speed RAMs such as magnetic disk storages and/or non-volatile memories, or one or more optical storage devices and/or flash memories (for example, NAND, NOR). The external memory unit 120 stores software which includes an operating system (OS) program, a communication program, a graphic program, a user interface program, a codec program, and one or more application programs. The term program is also represented as a set of instructions, an instruction set, or a module.

The OS program may indicate internal OS such as WINDOWS, LINUX, Darwin, RTXC, UNIX, OS X, or VxWorks, and may include several software components that control general system operations. These general system operations may mean memory management and control, storage hardware (device) control and management, and power control and management. Moreover, the OS program also may perform a function of making communication between a lot of hardware (devices) and software components (programs) smooth.

The communication program may enable communication with a counterpart device such as a computer, a server and the user device through the wireless communication unit 150 or the external port unit 170.

The graphic program includes several software components for providing and displaying graphics on the touch screen unit 180. The term graphics indicates a text, a web page, an icon, a digital image, a video, and animation.

The user interface program may include several software components related to the user interface. Moreover, the user interface program may include details on how the state of the user interface is changed or under which condition the state of the user interface is changed.

The codec program may include software components related to encoding and decoding video files.

The camera program may include camera related software components that enable camera related processes and functions.

The application module may include browser, email, instant message, word processing, keyboard emulation, address book, contact list (touch list), widget, Digital Right Management (DRM), voice recognition, voice copy and position determining functions, and a location based service.

The memory 110 may further include additional programs (instructions) in addition to the above-described programs. Moreover, the various functions of the user device 100 according to the present invention may be executed in hardware that includes one or more stream processing and/or application specific integrated circuits (ASICs), and/or in software and/or a combination thereof.

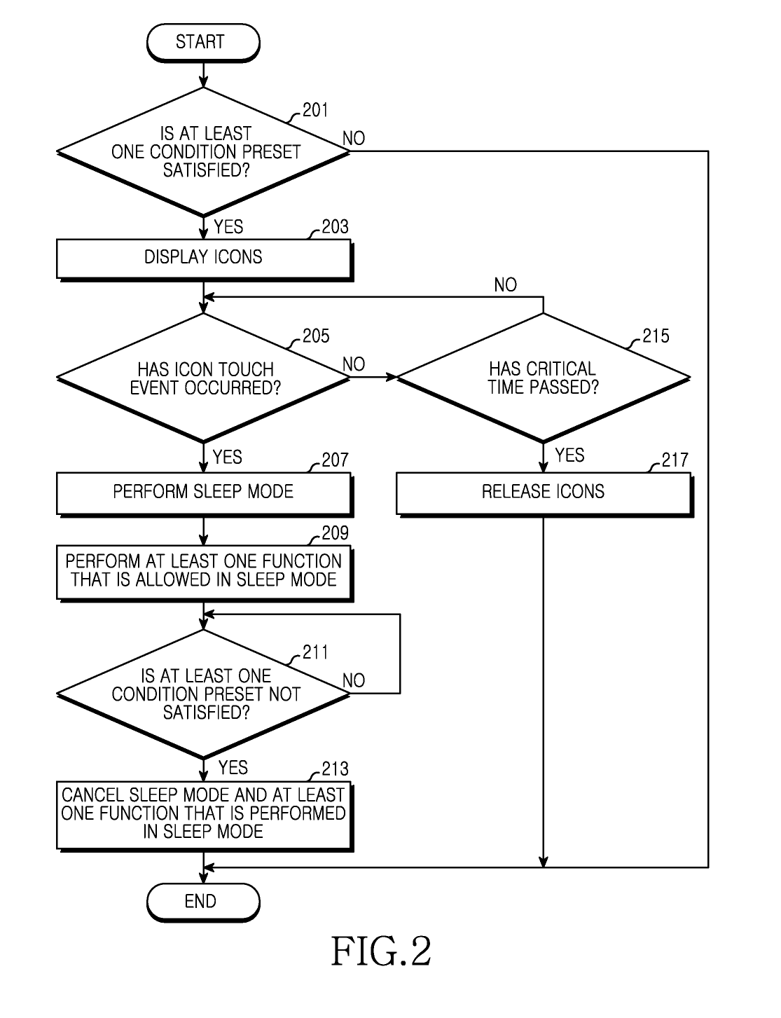

FIG. 2 is a flowchart of a procedure of performing a sleep mode according to an embodiment of the present invention.

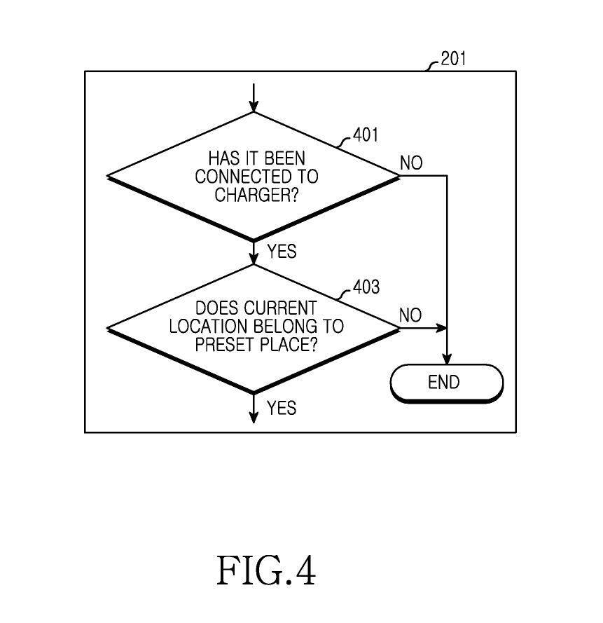

Referring to FIG. 2, in step 201, the processor 112 determines whether at least one of any preset conditions is satisfied. Step 201 will be described with reference to FIGS. 4 to 7.

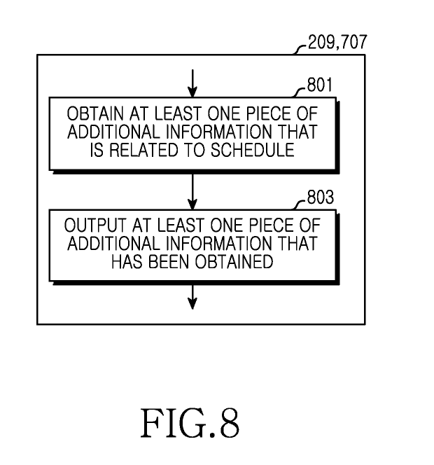

If at least one of the preset conditions is satisfied, the processor 112 displays a corresponding icon in step 203. The at least one preset condition may be related to at least one of a connection to a charger, a time zone, a place, and ambient illumination. For example, regarding step 209, the at least one preset condition may be satisfied in at least one case where the charger is connected, where the current time belongs to a designated time zone, where the current location belongs to a designated place, and where the current ambient illumination is lower than a threshold. Step 209 will be described with reference to FIGS. 8 to 11.

In step 205, the processor 112 determines whether an icon touch event occurs. Such an event may be a touch operation on a single icon, multiple icons, etc. When the icon touch event occurs, the processor 112 sets the mode of the user device 100 to a sleep mode and performs the sleep mode, in step 207. The sleep mode is a function that may be used when a user does not want to be disturbed due to an alarm or sounds associated with functions generated by the user device 100. The processor 112 processes text messages, multimedia messages or calls by using user defined modes (silent, lamp, auto response) if text messages, multimedia messages or calls are received in the sleep mode.

In step 209, the processor 112 performs at least one function that is allowed in the sleep mode. The at least one function that is allowed in the sleep mode includes providing user customized information. The user customized information is daily life information on a field related directly to user daily life, and may include, among other things, information on how to or where to purchase food or daily supplies, information on various events, notice of power blackouts or cutting off water, weather forecasts, traffic information, etc. The user customized information may be obtained on the basis of a time, a place, and a schedule.

In step 211, the processor 112 again determines whether at least one of the preset conditions is not satisfied. For example, at least one of the preset conditions may not be satisfied in at least one case where a charger is disconnected, where the current time is not in a designated time zone, where the current location is not a designated place, and the current ambient illumination is higher than a threshold.

If at least one of the preset conditions is not satisfied, the processor cancels a sleep mode and cancels the at least one function performed in the sleep mode, in step 213.

On the other hand, if an icon touch event does not occur in step 205, the processor 112 determines whether a critical time duration has been exceeded, in step 215. If the critical time has not been exceeded, the processor 112 returns to step 205. On the contrary, if the critical time has been exceeded, the processor 112 releases an icon in step 217 and the process ends.

According to an embodiment of FIG. 2, if a user touches an icon, a sleep mode and at least one function that is allowed in the sleep mode are performed. Moreover, if at least one of the above-described preset conditions is satisfied, the processor 112 may automatically execute the sleep mode and the at least one function that is allowed in the sleep mode, without displaying an icon.

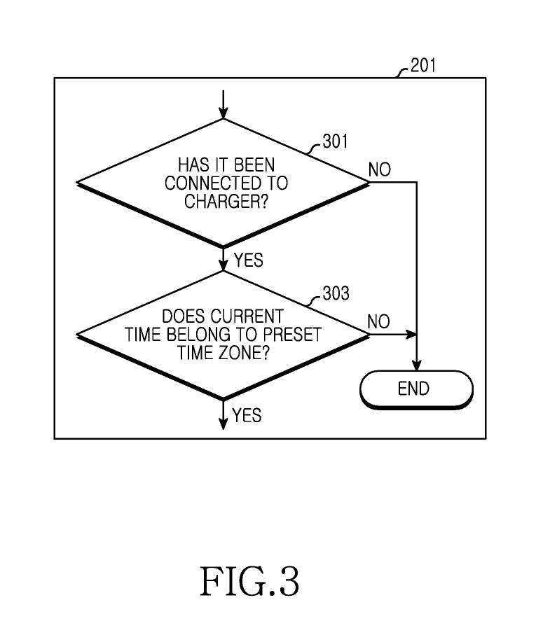

FIG. 3 is a flowchart related to step 201 of FIG. 2

Referring to FIG. 3, the processor 112 determines whether the user device is connected to a charger, in step 301.

If negative, the processor 112 ends this process. On the contrary, if it is determined that the user device is connected to the charger, the processor 112 determines whether the current time belongs to a preset time period, in step 303.

If the current time is not in the preset time period, the processor 112 ends this process. On the contrary, if the current time belongs to the preset time period, the processor 112 performs operations following step 203 described above.

A situation where the charger is connected to the user device 100 and the current time belongs to the preset time period (e.g., 11 PM to 4 AM) is an example of a situation where a user does not use the user device 100 or where the user is ready to sleep or is sleeping.

FIG. 4 is a flowchart related to step 201 of FIG. 2.

Referring to FIG. 4, the processor 112 determines whether the user device is connected to a charger, in step 401.

If negative, the processor 112 ends this process. On the contrary, if it is determined that the user device is connected to the charger, the processor 112 determines whether the user device 100 is currently located at a preset place, in step 403. The processor 112 may obtain location information from the GPS receiving unit 145 and make the determination by using the obtained location information where the user device 100 is located. For example, if a specific radius around the user's home is preset and the user device 100 enters the specific radius, the processor 112 determines the location of the user device 100 as the user's home.

If the current location is not the preset place, the processor 112 ends this process. On the contrary, if the current location belongs to the preset place, the processor 112 performs operations following step 203 described above. A situation where the charger is connected to the user device 100 and the user device 100 is located at the preset place (e.g., the user's home) is an example of a situation where a user does not use the user device 100 or where the user is ready to sleep or is sleeping.

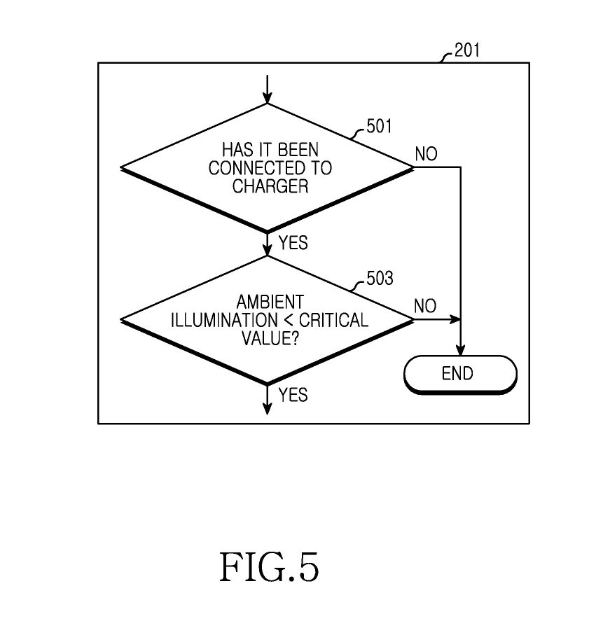

FIG. 5 is a flowchart related to step 201 of FIG. 2.

Referring to FIG. 5, the processor 112 determines whether the user device is connected to a charger, in step 501.

If negative, the processor 112 ends this process. On the contrary, if it is determined that the user device is connected to the charger, the processor 112 determines whether ambient illumination is lower than a critical threshold, in step 503. The processor 112 obtains the ambient illumination from the sensor unit 140 and performs step 503 with the obtained ambient illumination.

If the ambient illumination is higher than the threshold, the processor 112 ends this process. On the contrary, if the ambient illumination is lower than the threshold, the processor 112 performs operations following step 203 described above. A situation where the charger is connected to the user device 100 and the ambient illumination is lower than the threshold is an example of a situation where a user does not use the user device 100 or where the user is ready to sleep or is sleeping.

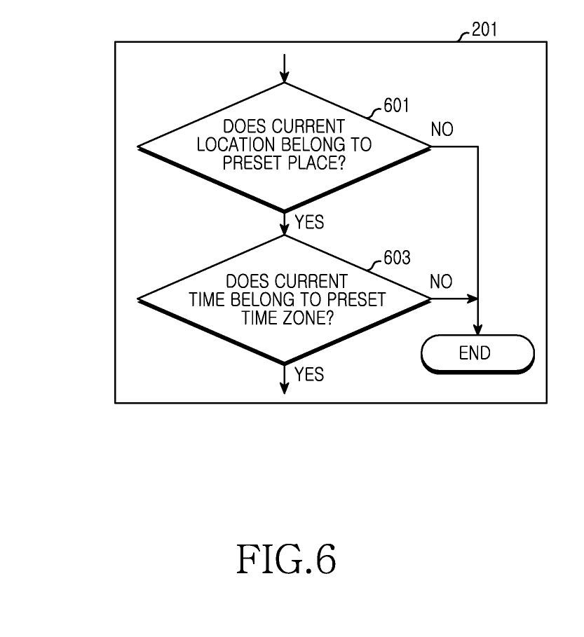

FIG. 6 is a flowchart related to step 201 of FIG. 2.

Referring to FIG. 6, the processor 112 determines whether the current location belongs to a preset place, in step 601.

If negative, the processor 112 ends this process. On the contrary, if the current location belongs to the preset place, the processor 112 determines whether the current time belongs to a preset time period.

If the current time is not in the preset time period, the processor 112 ends this process. On the contrary, if the current time belongs to the preset time period, the processor 112 performs operations following step 203 described above. A situation where the current time belongs to the preset time period (e.g., 11 PM to 5 AM) and the user device 100 is located at the preset place (e.g., the user's home) is an example of a situation where a user does not use the user device 100 or where the user is ready to sleep or is sleeping.

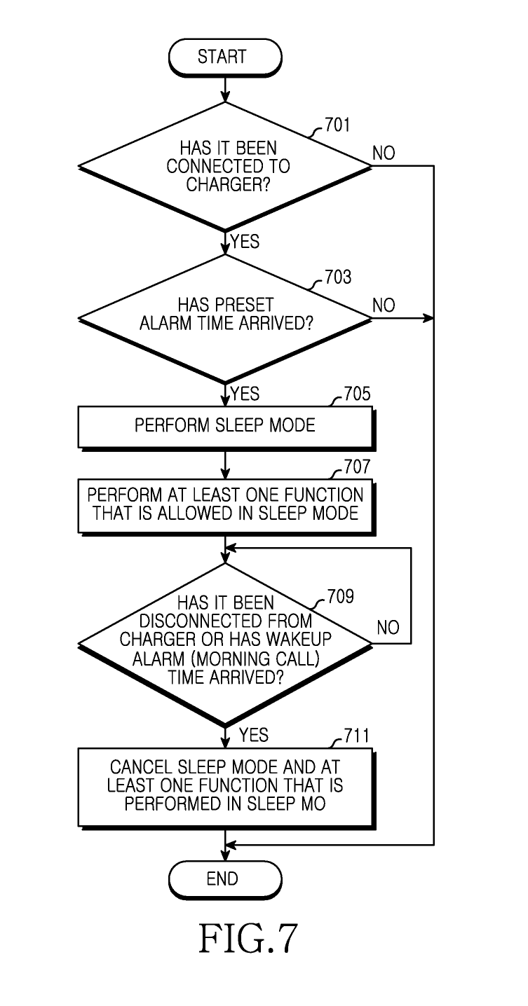

FIG. 7 is a flowchart of the procedure of performing a sleep mode according to an embodiment of the present invention.

Referring to FIG. 7, the processor 112 determines whether the user device is connected to a charger, in step 701.

If negative, the processor 112 ends this process. On the contrary, if it is determined that the user device is connected to the charger, the processor 112 determines whether an alarm time arrives, in step 703.

If the alarm time does not arrive, the processor 112 ends this process. On the contrary, if the alarm time arrives, the processor 112 sets the mode of the user device 100 to a sleep mode and performs the sleep mode, in step 705. The sleep mode is a function that may be used when a user does not want to be disturbed. The processor 112 processes text messages, multimedia messages or calls by using user defined modes (silent, lamp, auto response) if the text messages, multimedia messages or calls are received in the sleep mode.

In step 707, the processor 112 performs at least one function that is allowed in the sleep mode. The at least one function that is allowed in the sleep mode includes providing user customized information. As described above, the user customized information is daily life information on a field related directly to user daily life, and may include information on how to or where to purchase food or daily supplies, information on various events, etc. The user customized information may be obtained on the basis of a time, a place, and a schedule. Step 707 will be described with reference to FIGS. 8 to 11.

In step 709, the processor 112 determines whether a charger is disconnected or whether a wakeup alarm (morning call) time arrives.

If the charger is connected or the wakeup alarm time does not arrive, the processor 112 maintains the sleep mode and the at least one function that is being performed. On the contrary, if the charger is disconnected or the wakeup alarm time arrives, the processor 112 cancels the sleep mode and the at least one function that is being performed in the sleep mode, in step 711.

FIG. 8 is a flowchart related to step 209 of FIG. 2 and step 707 of FIG. 7.

Referring to FIG. 8, the processor 112 obtains at least one piece of additional information that is related to a schedule, in step 801. The additional information is stored in the user device 100 or provided from an outside source such as a social network. The additional information is daily life information on a field related directly to user daily life, as described above.

In step 803, the processor 112 outputs the obtained at least one piece of additional information. The additional information is output through the touch screen unit 180 if it is a video type, and is output through the speaker 161 if the additional information is an audio type. Moreover, the processor 112 may also change a displayed text to sound through a text to speech (TTS) function and then output the sound through the speaker 161.

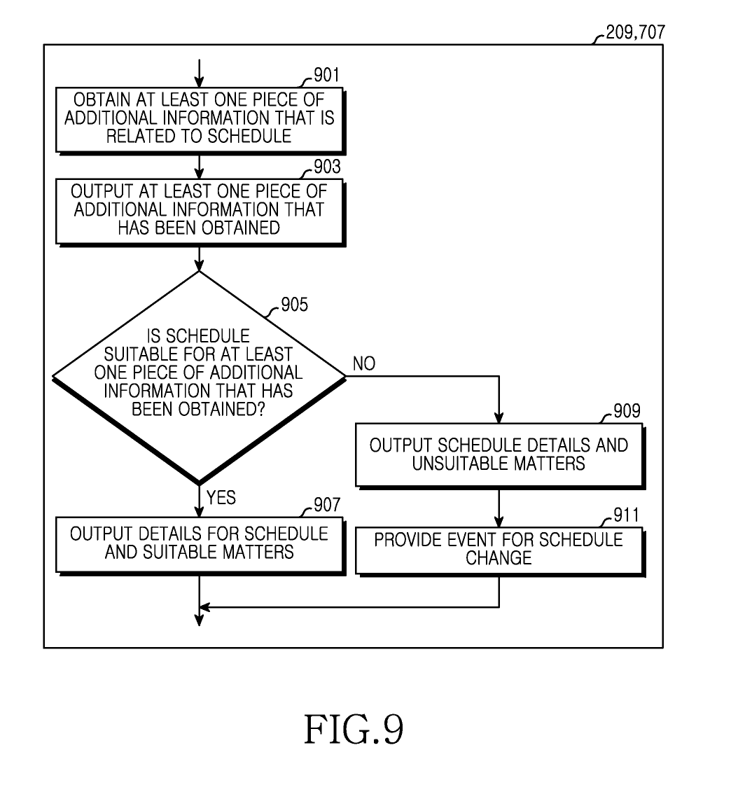

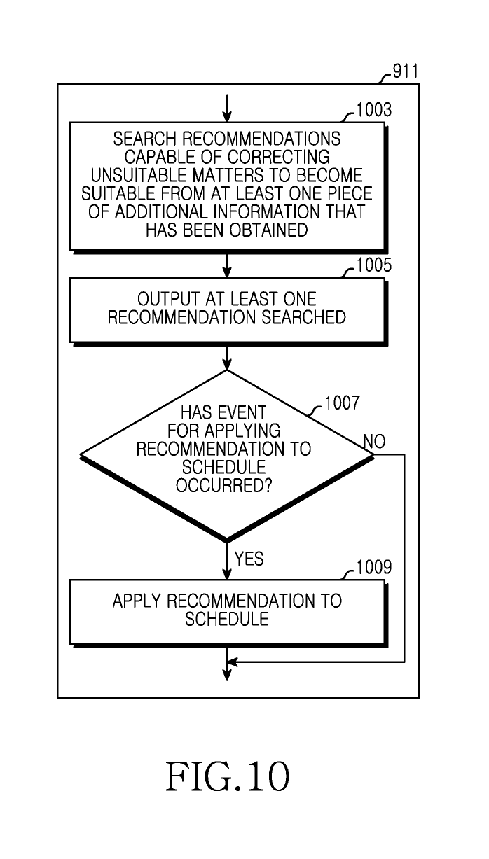

FIG. 9 is a flowchart related to step 209 of FIG. 2 and step 707 of FIG. 7.

Referring to FIG. 9, the processor 112 obtains at least one piece of additional information that is related to a schedule, in step 901. For example, a schedule that is registered for the next day may be organized as Table 1 below and its details are set to include items such as date and time, place, something to do, and participants.

TABLE 1

| | | | Something | | |
|---|---|---|---|---|---|
| | Date and time | Place | to do | Participants | . . . |
| Schedule | January 2, | Han-River | Baseball | TOM | . . . |
| | at 2 PM | Park | | | |

The processor 112 controls the user device so that the user device obtains additional information on at least one of “January 2, at 2 PM” of the item Date and time, “Han-River Park” of the item Place, “Baseball” of the item Something to do, and “TOM” of the item Participants, and additional information on two or more combinations thereof, and provides the obtained additional information. For example, the processor 112 determines the category of the schedule as an outdoor activity from “Han-River Park” of the item Place and “Baseball” of the item Something to do. The processor 112 obtains weather information on Han-River Park, January 2, at 2 PM from “January 2, at 2 PM” of the item Date and time and “Han-River Park” of the item Place. That is, the processor 112 obtains weather information related to an outdoor activity, and the weather information may be searched and obtained through the web.

In step 903, the processor 112 outputs the obtained at least one piece of additional information along with the schedule through an output unit (a display, a speaker, etc.). The additional information may be content that includes at least one of a text, an image, voice, music, a moving picture, and a Uniform Resource Locator (URL), and may be provided as a widget. For example, when the obtained weather information is “rain”, a rain image, rainfall, a temperature, relative humidity, wind, a comfort index, etc., are together displayed. Moreover, if the obtained weather information is “serenity”, a serenity image, a temperature, relative humidity, wind, a comfort index, etc., are together displayed. Moreover, the processor 112 may also display images that are captured from the Closed Circuit TeleVision (CCTV) that may be available at Han-River Park through a corresponding server.

In step 905, the processor 112 determines on the basis of the obtained at least one piece of additional information whether the schedule is suitable. That the schedule is suitable means that a user may easily perform the schedule, and on the contrary, that the schedule is unsuitable means that it may be difficult for the user to perform the schedule. For example, it may be determined on the basis of the weather information “rain” that an outdoor activity schedule is unsuitable, and thus the processor 112 determines that the schedule is unsuitable. Moreover, it may be determined on the basis of the weather information “serenity” that an outdoor activity schedule is suitable, and thus the processor 112 determines that the schedule is suitable.

When a schedule is suitable for the obtained at least one piece of additional information, the processor 112 outputs the details for the schedule and suitable matters in step 907. For example, the processor 112 determines on the basis of the weather information “serenity” that an outdoor activity schedule is suitable, and may output schedule details and the text or voice message “The weather is good for outdoor activities” as suitable matters. Moreover, the processor 112 may search a contact number related to “TOM” of the item Participants and also transmit to the searched contact number the suitable matter “The weather is good for outdoor activities” in a text or voice message.

When a schedule is unsuitable for the obtained at least one piece of additional information, the processor 112 outputs schedule details and unsuitable matters in step 909. For example, the processor 112 may determine on the basis of the weather information “rain” that an outdoor activity schedule is unsuitable, and outputs schedule details and the text or voice message “The weather is not good for outdoor activities” as unsuitable matters. Moreover, the processor 112 may search a contact number related to “TOM” of the item Participants and also transmit, to the searched contact number, the schedule and the above-described unsuitable matter “The weather is not good for outdoor activities” in a text or voice message.

In step 911, the processor 112 provides an event for schedule change or rearrangement. Such an event may include a text or voice message and induce a user to rearrange his/her schedule. The processor 112 searches, from the obtained at least one piece of addition information, recommendations capable of suitably correcting the unsuitable matter of the schedule, and outputs the searched recommendations. In the above-described example, the processor 112 outputs recommendations on a time period good for outdoor activities, day of the week, and place in a text or voice message. For example, the processor outputs a message that contains the recommendation “Weather at 4 PM is better than that at 2 PM for outdoor activities. Do you want to modify the schedule?”, and if a user accepts the modification, the schedule is automatically rearranged to reflect the recommendation. Moreover, the processor outputs a message that reflects the recommendation “Weather at 4 PM is good for outdoor activities. Do you want to inform participants?”, and if the user accepts it, this message is transmitted to the contact number of the participant “TOM”.

FIG. 10 is a flowchart related to step 911 of FIG. 9.

Referring to FIG. 10, in step 1003, the processor 112 searches a recommendation capable of correcting an unsuitable matter, from the obtained at least one piece of additional information. In the above-described example of FIG. 9, such a recommendation may be a time period suitable for outdoor activities, day of the week, a place, etc.

In step 1005, the processor 112 outputs at least one searched recommendation.

In step 1007, it is determined whether an event for applying the recommendation to the schedule occurs.

If the event occurs, the processor 112 applies the recommendation to the schedule in step 1009. That is, the schedule is changed or rearranged.

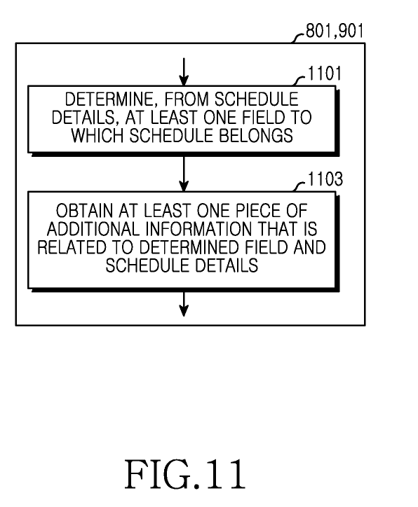

FIG. 11 is a flowchart related to step 801 of FIG. 8 and step 901 of FIG. 9.

Referring to FIG. 11, in step 1101, the processor 112 determines, on the basis of schedule details, at least one field or category to which a schedule belongs. Such a category may be an outdoor activity, an indoor activity, a variable place, etc.

In step 1103, the processor 112 obtains at least one piece of additional information that is related to the determined at least one category and schedule details. For example, when the category is the outdoor activity, weather information may be obtained on date and time, place, etc.

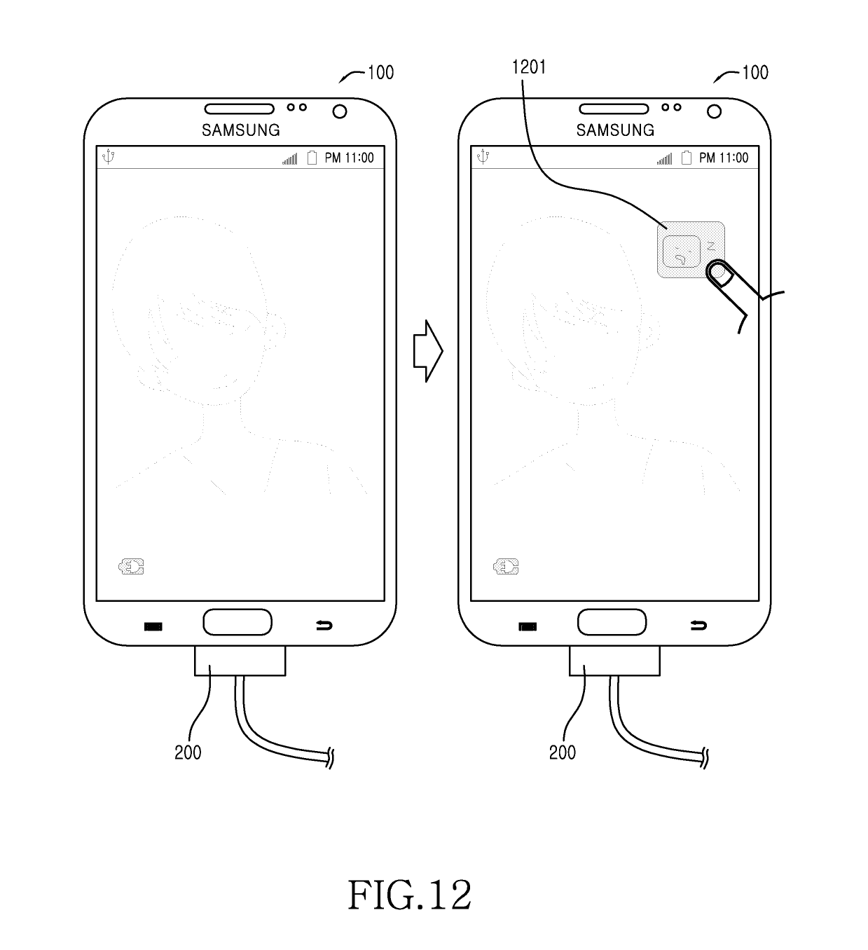

FIG. 12 is a screen of a user device according to an embodiment of the present invention.

Referring to FIG. 12, a plug connector 200 coupled to a cable end of a charger is electrically coupled to a socket connector of the user device 100. The user device 100 senses that the charger is connected, and then displays an icon 1201 that indicates a sleep mode. A user touches icon 1201 and the user device 100 executes the sleep mode and at least one function that is allowed in the sleep mode. However, if the icon 1201 is displayed and then an event where the icon 1201 is touched does not occur for a certain time, the icon 1201 is released.

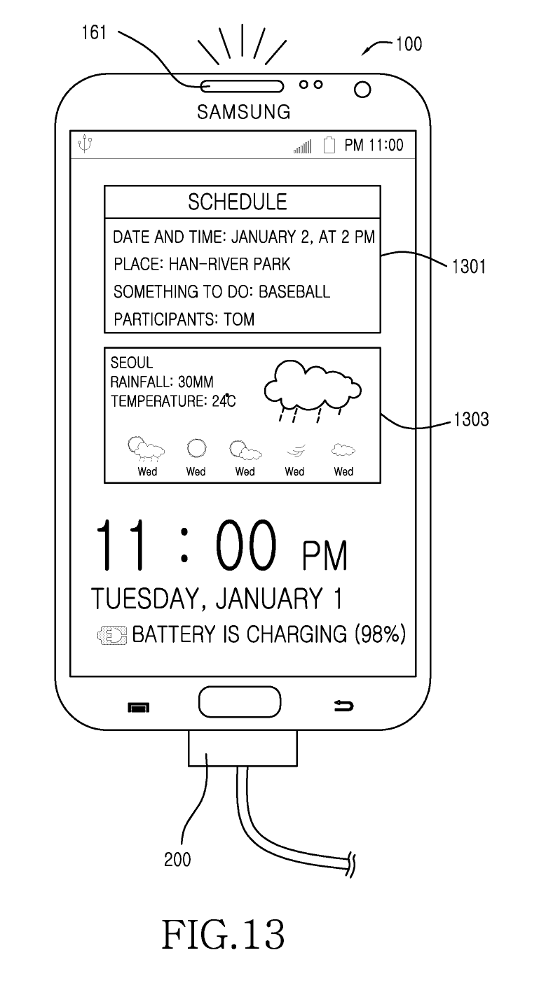

FIGS. 13 to 20B are screens of a user device regarding a sleep mode according to an embodiment of the present invention.

Referring to FIG. 13, the user device 100 searches a schedule, and displays the searched schedule through a window 1301. Moreover, the user device 100 may output the searched schedule by voice through the speaker 161, and in this case the user device may change a displayed text to sound through a text-to-speech (TTS) function and then output the sound. Moreover, the user device 100 determines a category (e.g., an outdoor activity) to which a schedule belongs, obtains and displays additional information corresponding to the determined category. As shown, if it is determined that the schedule category is the outdoor activity, weather information is displayed through the window 1303. The schedule includes a plurality of items that include date and time, place, something to do, and participants, and details on the items are determined by a user input. In particular, weather information is associated with a detail on at least one item of the schedule and obtained through a corresponding server. For example, the user device 100 determines on the basis of “January 2, at 2 PM” of the item Date and time, “Han-River Park” of the item Place, “Baseball” of the item Something to do, that the schedule category is the outdoor activity, and obtains, from a corresponding server, information on the weather of Han-River Park, for January 2, at 2 PM, and displays the obtained weather information.

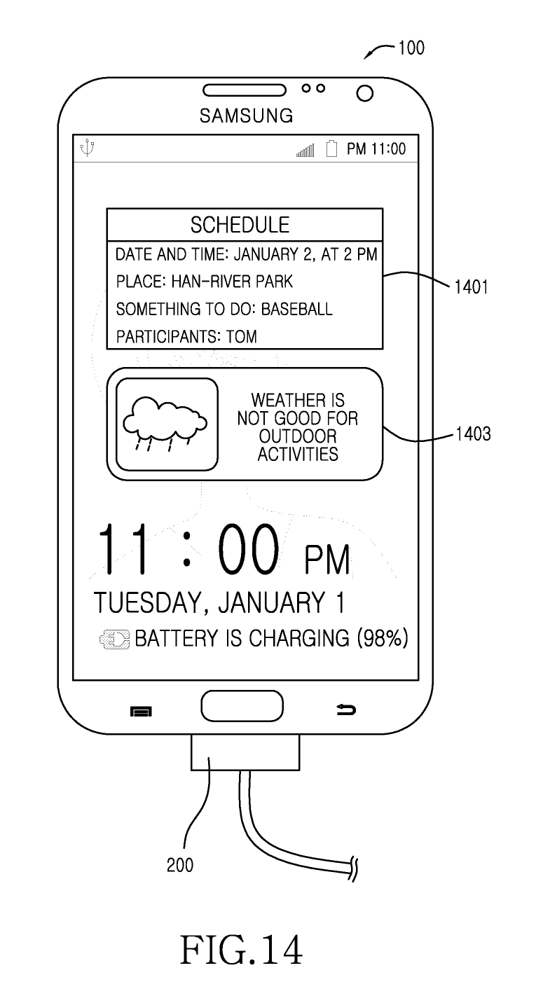

Referring to FIG. 14, the user device 100 searches a schedule, and displays the searched schedule through a window 1401. Moreover, the user device 100 determines a category to which the schedule belongs, and obtains additional information corresponding to the determined category. In particular, the user device 100 determines on the basis of such additional information whether the schedule is suitable, and displays the result through the window 1403. For example, the user device 100 determines on the basis of “January 2, at 2 PM” of the item Date and time, “Han-River Park” of the item Place, “Baseball” of the item Something to do, that the schedule is related to the outdoor activity, and obtains, from a corresponding server, information on the weather of Han-River Park, January 2, at 2 PM, and displays the obtained weather information. When the obtained weather information is “rain”, the user device 100 determines that the weather information “rain” is unsuitable for an outdoor activity schedule, and informs the participants of it. As shown, the user device displays, through the window 1403, an unsuitable matter that contains the phrase “The weather is not good for outdoor activities” and a rain image.

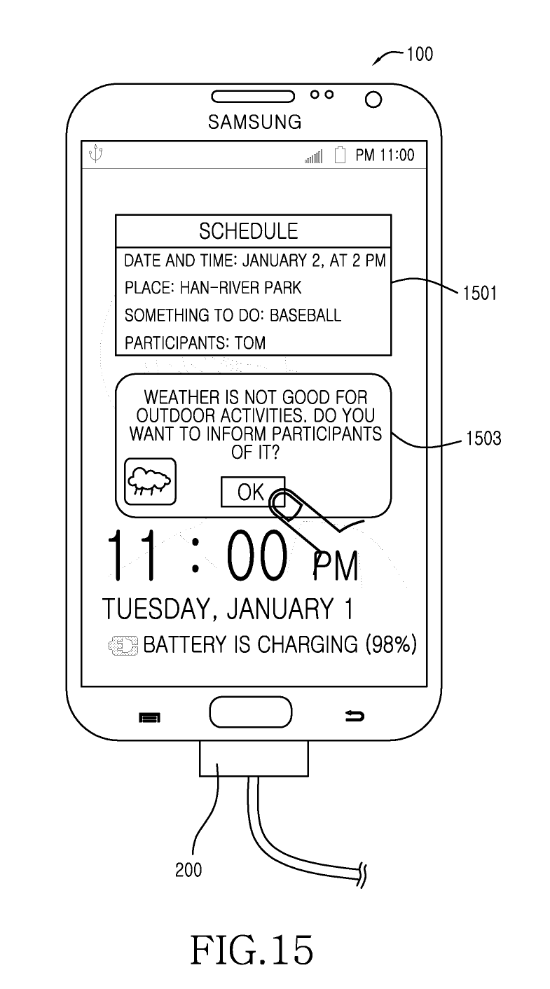

Referring to FIG. 15, the user device 100 searches a schedule, and displays the searched schedule through a window 1501. Moreover, the user device 100 determines a category to which the schedule belongs, and obtains additional information corresponding to the determined category. In particular, the user device 100 determines on the basis of such additional information whether the schedule is suitable, and displays the result through the window 1503. For example, the user device 100 determines on the basis of “January 2, at 2 PM” of the item Date and time, “Han-River Park” of the item Place, “Baseball” of the item Something to do, that the schedule is related to the outdoor activity, and obtains, from a corresponding server, information on the weather of Han-River Park, January 2, at 2 PM, and displays the obtained weather information. When the obtained weather information is “rain”, the user device 100 determines that the weather information “rain” is unsuitable for an outdoor activity schedule, and informs the participants of it. As shown, the user device displays, through the window 1503, an unsuitable matter that contains the phrase “The weather is not good for outdoor activities” and a rain image. In particular, when the participant “TOM” is included in the item participants, a button that causes an event through which the result may be sent to the participant is provided on the window 1503. If a user touches this button, the user device 100 searches a contact number related to “TOM” and transmits the schedule details and the unsuitable matters to the searched contact number by using a text message.

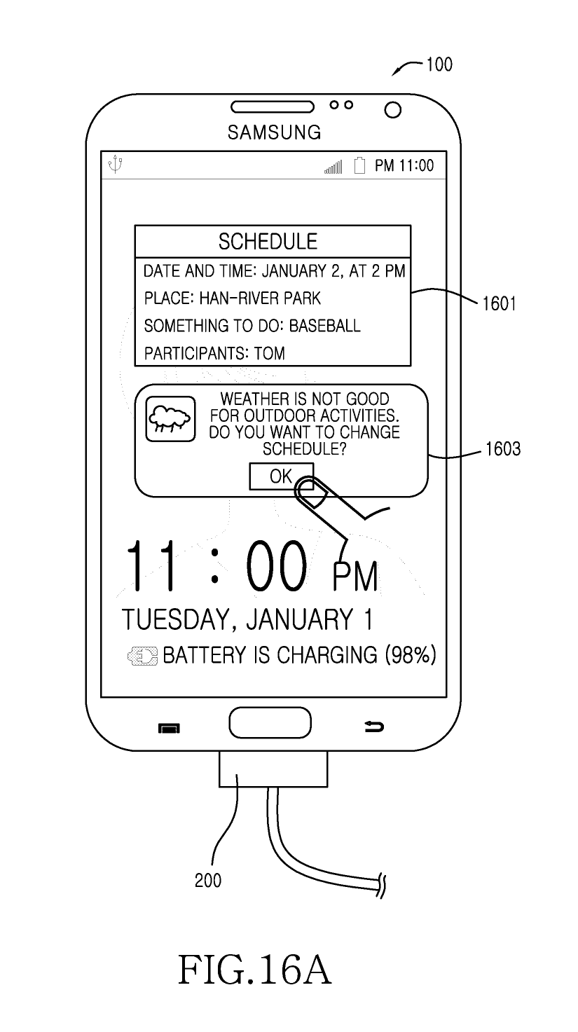

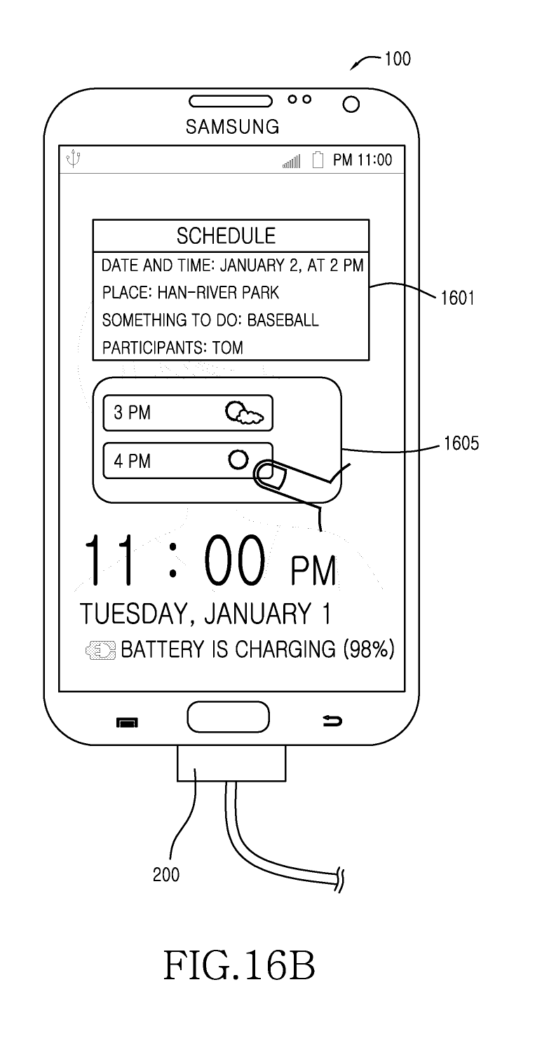

Referring to FIGS. 16A and 16B, the user device 100 searches a schedule, and displays the searched schedule through a window 1601. Moreover, the user device 100 determines a category to which the schedule belongs, and obtains additional information corresponding to the determined category. In particular, the user device 100 determines on the basis of such additional information whether the schedule is suitable, and displays the result through the window 1603. For example, the user device 100 determines on the basis of “January 2, at 2 PM” of the item Date and time, “Han-River Park” of the item Place, “Baseball” of the item Something to do, that the schedule is related to the outdoor activity, and obtains, from a corresponding server, information on the weather of Han-River Park, January 2, at 2 PM, and displays the obtained weather information. When the obtained weather information is “rain”, the user device 100 determines that the weather information “rain” is unsuitable for an outdoor activity schedule, and informs the participants of it. As shown, the user device displays, through the window 1603, an unsuitable matter that contains the phrase “The weather is not good for outdoor activities” and a rain image. In particular, the window 1603 provides a button that may cause an event through which the schedule may be changed or rearranged. If a user touches this button, the user device 100 searches at least one time having weather (e.g., serenity, cloud, etc.) suitable for outdoor activities, and provides the searched at least one time as a touchable list through the window 1605, as seen in FIG. 16B. The list displays a time suitable for outdoor activities and an image representing weather that is suitable for outdoor activities. The user touches one item on the list and the user device 100 performs a rearranging of the schedule by reflecting the time corresponding to the touched item to the schedule. Moreover, as described above, the user device 100 may also provide an event for transmitting such a schedule rearrangement to the participants.

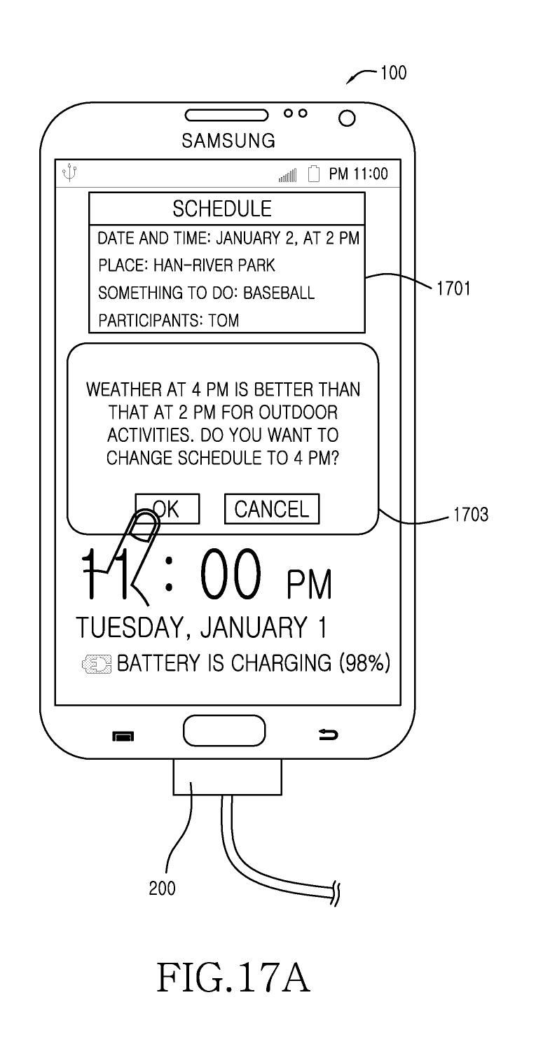

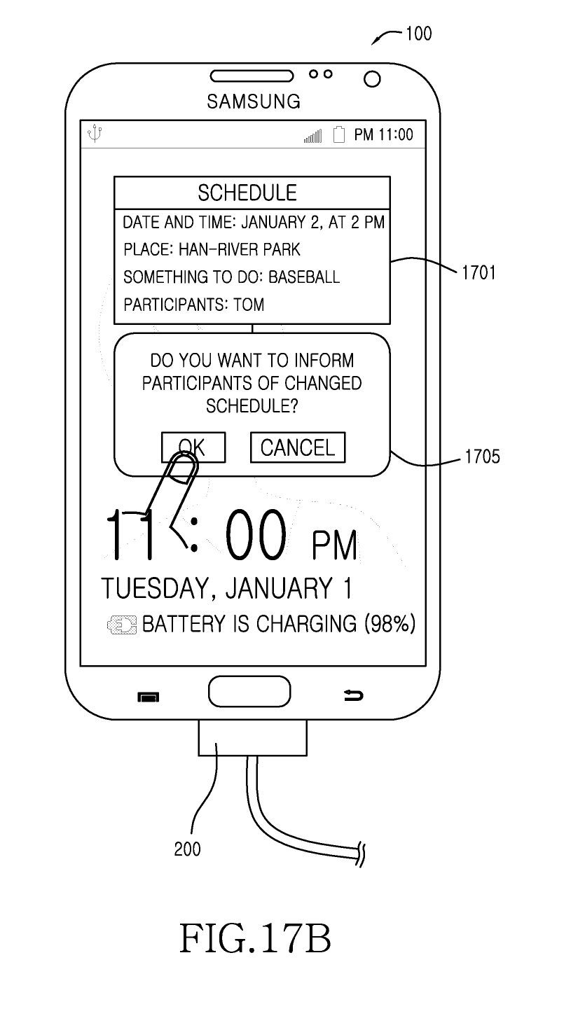

Referring to FIGS. 17A and 17B, the user device 100 searches a schedule, and displays the searched schedule through a window 1701. Moreover, the user device 100 determines a category to which the schedule belongs, and obtains additional information corresponding to the determined category. In particular, the user device 100 determines on the basis of such additional information whether the schedule is suitable, and displays the result through the window 1703. For example, the user device 100 determines on the basis of “January 2, at 2 PM” of the item Date and time, “Han-River Park” of the item Place, “Baseball” of the item Something to do, that the schedule is related to the outdoor activity, obtains, from a corresponding server, information on the weather of Han-River Park, January 2, at 2 PM, and when the obtained weather information is “rain”, and the user device 100 determines that the weather information “rain” is unsuitable for an outdoor activity schedule. Moreover, the user device 100 determines when weather suitable for outdoor activities exists among a time period (e.g., 4 PM) and provides the window 1703 along with the phrase “Weather at 4 PM is better than that at 2 PM for outdoor activities. Do you want to rearrange schedule for 4 PM?” and a button that causes an event for rearranging the schedule. If the user touches this button, the user device 100 changes the schedule from 2 PM to 4 PM. Moreover, the user device 100 provides a window 1705 as in FIG. 17B along with a button that causes an event for transmitting such a schedule change to participants. If the user touches this button, the user device 100 transmits the changed schedule details to the participants.

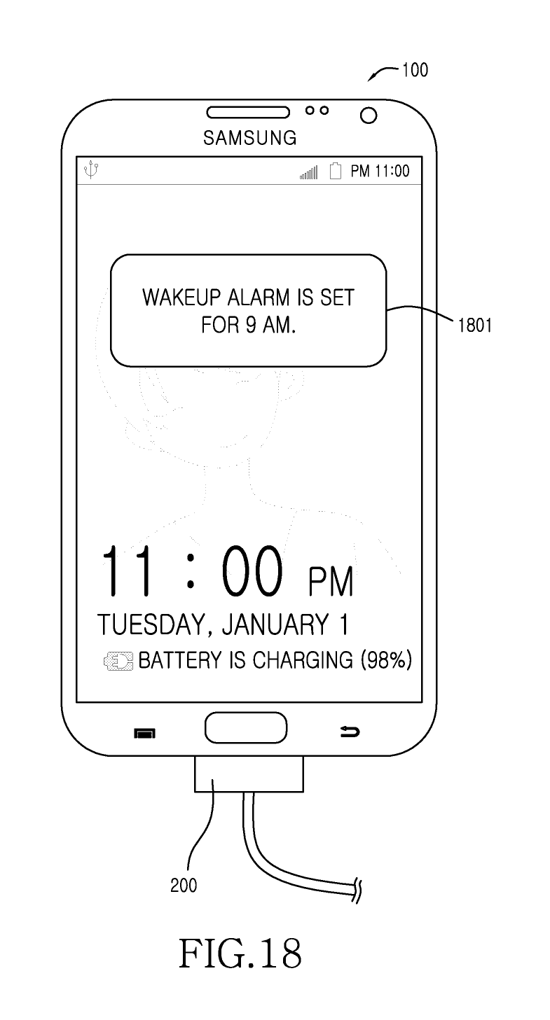

Referring to FIG. 18, the user device 100 determines if a wakeup alarm is set and displays wakeup alarm details through a window 1801. Moreover, the user device 100 may output the wakeup alarm details by voice through the speaker 161.

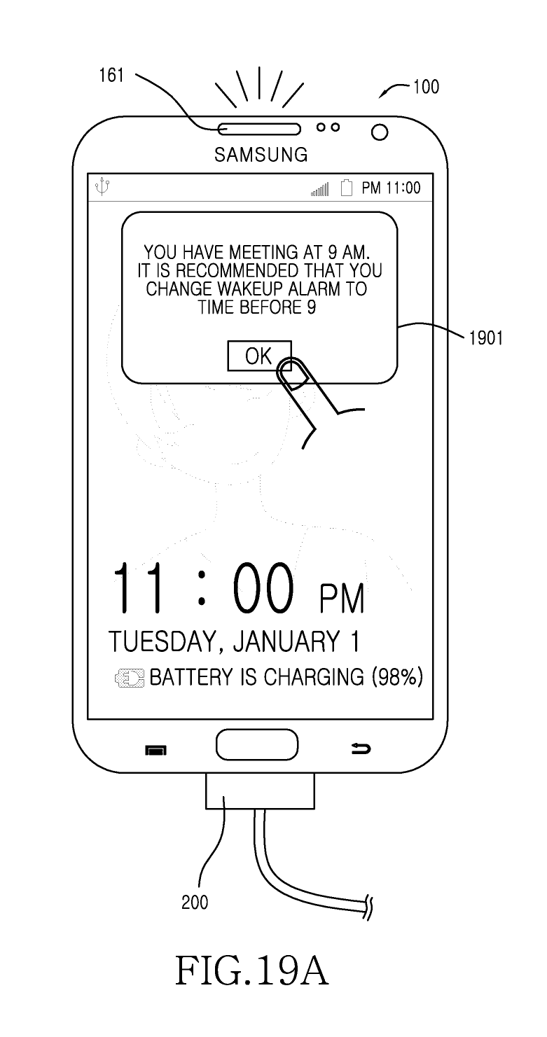

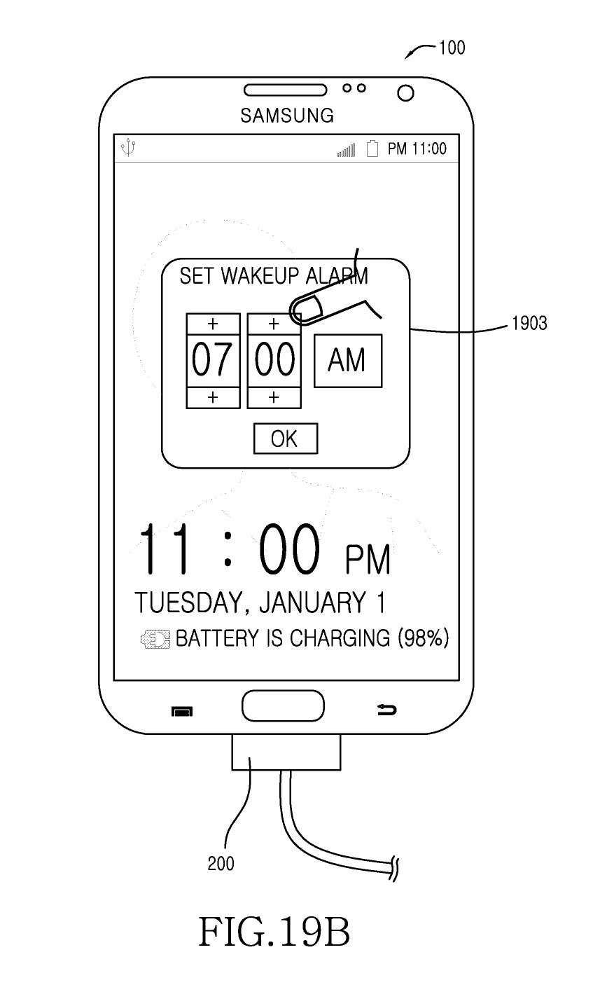

Referring to FIGS. 19A and 19B, the user device 100 determines a wakeup alarm time. Moreover, the user device 100 checks the start time of a corresponding schedule. If the wakeup alarm time is set to be later than the start time of the corresponding schedule, the user device 100 determines that the wakeup alarm is unsuitable and provides a window 1901 along with unsuitable matters and a button that causes an event for the change of the wakeup alarm time. If the user touches this button, the user device 100 provides may provide a window 1903 as in FIG. 19B through which the wakeup alarm time may be set, manipulated and changed. On the other hand, it is possible to change the wakeup alarm time by using a voice recognition technology. For example, if the user receives the unsuitable matters between a schedule and the wakeup alarm and speaks a desired wakeup alarm time, the user device 100 may also change the wakeup alarm time through voice recognition.

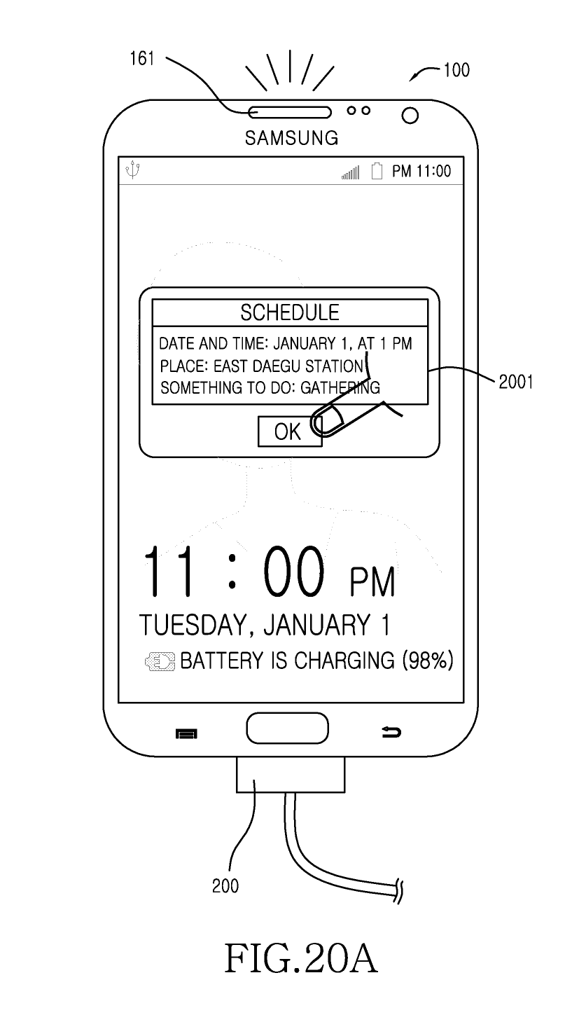

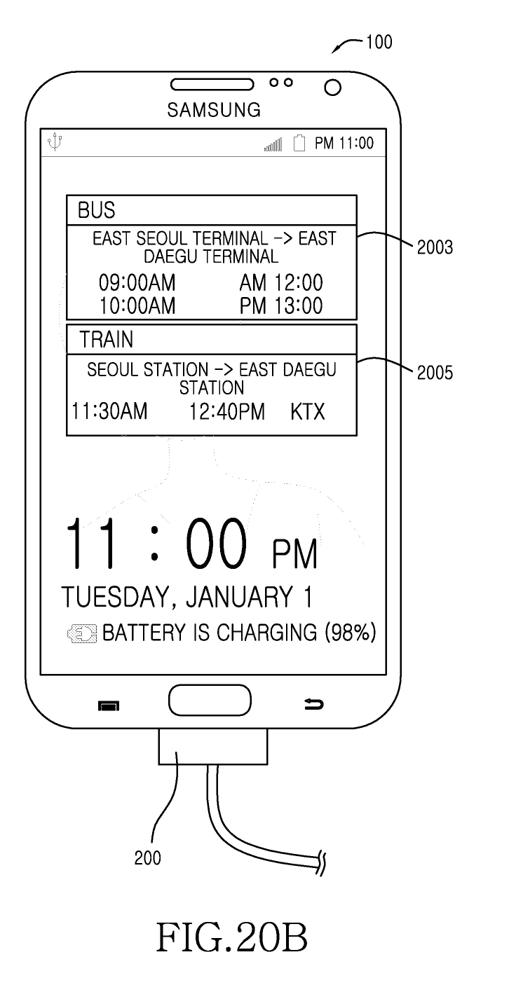

Referring to FIGS. 20A and 20B, the user device 100 determines a schedule and displays schedule details through a window 2001. The user device 100 may also output the schedule details by voice through the speaker 161. Moreover, the user device 100 determines a category to which the schedule belongs (e.g., weather, traffic, food, etc.), obtains and displays additional information corresponding to the determined category, and if the schedule category is associated with a movement, the user device obtains traffic information and the obtained traffic information is displayed through windows 2003 and 2005 as in FIG. 20B. The schedule includes a plurality of items which include date and time, place, something to do, etc., and schedule details are determined by user input. Such traffic information is associated with details for at least one item of the schedule and is obtained through a corresponding server. For example, the user device 100 determines on the basis of “January 2, at 1 PM” of the item Date and time, “East Daegu Station” of the item Place, and “Gathering” of the item Something to do, that the schedule is related to a movement. The user device 100 recommends a bus, a train, etc., and in particular, provides information on a bus and a train that start for East Daegu Station from the current location and that may arrive before January 2, at 1 PM.

The user device and the operation method thereof according to the present invention may satisfy the usability of the user device and user satisfaction throughout the user's life even when the user does not use the user device, such as when the user device is being charged or a user is sleeping. In particular, the user device provides upcoming schedule and information related to such a schedule, and determines on the basis of the information whether the schedule is suitable; that is, whether the user has a difficulty in performing the schedule. Moreover, it is possible to improve a user customized service since the user device informs the user of the unsuitability of the schedule and induces the user to change the schedule in consideration of the obtained information when the schedule is unsuitable.

Moreover, methods according to embodiments described in the following claims and/or the specification of the present invention may be implemented in hardware, in software or as a combination thereof.

When the methods are implemented in software, a computer readable recording medium that stores one or more programs (software modules) may be provided. One or more programs stored in the computer readable recording medium are configured to be able to be executed by one or more processors in the user device. One or more programs include instructions that allow the user device to execute the methods according to the embodiments described in the claims and/or the description of the present invention herein.

Such programs (software modules or software) may be stored in random access memories (RAMs), non-volatile memories including flash memories, read only memories (ROM), Electrically Erasable Programmable Read Only Memories (EEPROMs), magnetic disc storage devices, Compact Disc-ROMs (CD-ROMs), Digital Versatile Discs (DVDs), other types of optical storage devices, or magnetic cassette. Alternatively, the programs may be stored in a memory that consists of a combination of some or all thereof. Moreover, each component memory may be included in plural.

While particular embodiments have been described in the detailed description of the present invention, several variations may be made without departing from the scope of the present invention. Therefore, the scope of the present invention should not be limited to the above-described embodiments but be defined by the following claims and equivalents thereof.

What is claimed is:

1. An operation method of a user device comprising:
performing a sleep mode if at least one condition that is preset is satisfied; and
performing at least one function that is allowed in the sleep mode.

2. The operation method of claim 1, wherein the preset at least one condition comprises at least one of a connection to a charger, a time, a place, ambient illumination, and an alarm time.

3. The operation method of claim 1, further comprising canceling the sleep mode and the at least one function if a wakeup alarm time arrives.

4. The operation method of claim 1, further comprising displaying a corresponding icon if the preset at least one condition is satisfied.

5. The operation method of claim 4, further comprising performing the sleep mode and the at least one function if a touch event for the icon occurs.

6. The operation method of claim 4, further comprising releasing the icon if a touch event for the icon does not occur within a critical time.

7. The operation method of claim 1, wherein the at least one function comprises:
obtaining at least one piece of additional information that is related to a schedule; and
outputting the obtained at least one piece of additional information.

8. The operation method of claim 7, wherein obtaining the at least one piece of additional information that is related to the schedule comprises:
determining, on a basis of details for the schedule, at least one category to which the schedule belongs to; and
obtaining at least one piece of additional information that is related to the determined at least one category and the schedule details.

9. The operation method of claim 7, further comprising:
determining whether the schedule is suitable for the at least one piece of additional information;
outputting schedule details and suitable matters if the schedule is suitable; and
outputting the schedule details and unsuitable matters if the schedule is unsuitable.

10. The operation method of claim 10, further comprising:
searching, from the at least one piece of additional information, at least one recommendation with which the unsuitable matters are corrected to become suitable; and
outputting the searched at least one recommendation.

11. The operation method of claim 10, further comprising applying the recommendation to the schedule.

12. The operation method of claim 1, wherein the at least one function comprises informing a user of the user device that a wakeup alarm is unsuitable for a schedule, if a wakeup alarm time is later than a start time of the schedule.

13. A user device comprising:
at least one processor;
a memory; and
at least one program stored in the memory, wherein the at least one program is configured to be executable by the at least one processor, performs a sleep mode if at least one condition that is preset is satisfied, and performs at least one function that is allowed in the sleep mode.

14. The user device of claim 13, wherein the preset at least one condition comprises at least one of a connection to a charger, a time, a place, ambient illumination, and an alarm time.

15. The user device of claim 13, wherein the at least one program cancels the sleep mode and the at least one function if a wakeup alarm time arrives.

16. The user device of claim 13, wherein a corresponding icon is displayed if the preset at least one condition is satisfied.

17. The user device of claim 16, wherein the at least one program performs the sleep mode and the at least one function if an event for selecting the icon occurs.

18. The user device of claim 16, wherein the at least one program releases the icon if an event for selecting the icon does not occur within a critical time.

19. The user device of claim 13, wherein the at least one function comprises obtaining at least one piece of additional information that is related to a schedule, and outputting the obtained at least one piece of additional information.

20. The user device of claim 19, wherein the at least one program determines, on a basis of details for the schedule, at least one category to which the schedule belongs to, and obtains at least one piece of additional information that is related to the determined at least one category and the schedule details.

21. The user device of claim 19, wherein the at least one program determines whether the schedule is suitable for the at least one piece of additional information, outputs the schedule details and suitable matters if the schedule is suitable, and outputs the schedule details and unsuitable matters if the schedule is unsuitable.

22. The user device of claim 21, wherein the at least one program searches, from the at least one piece of additional information, at least one recommendation with which the unsuitable matters are corrected to become suitable, and outputs the searched at least one recommendation.

23. The user device of claim 22, wherein the at least one program applies the recommendation to the schedule.

24. The user device of claim 13, wherein the at least one function comprises informing a user of the user device that a wakeup alarm is unsuitable for a schedule, if a wakeup alarm time is later than a start time of the schedule.
